(19) United States
(12) Patent Application Publication
(10) Pub. No.: US 2026/0106785 A1
(43) Pub. Date: Apr. 16, 2026

(54) DYNAMIC TDD POLICY ADAPTATION

(71) Applicant: HEWLETT PACKARD ENTERPRISE DEVELOPMENT LP, Spring, TX (US)

(72) Inventors: Shivang AGGARWAL, Spring, TX (US); Ahmad HASSAN, Spring, TX (US); Mohamed AHMED, Spring, TX (US); Puneet SHARMA, Milpitas, CA (US)

(21) Appl. No.: 19/035,235

(22) Filed: Jan. 23, 2025

Related U.S. Application Data
(60) Provisional application No. 63/705,616, filed on Oct. 10, 2024.

(51) Int. Cl. H04L 27/26; H04B 7/06; H04L 43/08

(52) U.S. Cl. CPC H04L 27/2656; H04B 7/0632; H04L 43/08

(57) ABSTRACT

Systems and methods are provided for dynamic adjustment of a Time Division Duplex (TDD) policy at a base station (BS). The dynamic adjustment is achieved by predicting an optimal uplink (UL) and downlink (DL) slots and symbols distribution according to which BS resources are assigned taking into account BS-level operating characteristics. Once an optimal UL and DL slots and symbols distribution is predicted, transitions between UL and DL transmissions are smoothed, and an optimum arrangement of UL and DL slots and symbols distribution is selected that balances inter-slot delay and guard period overhead.

### CROSS-REFERENCE TO RELATED APPLICATIONS

This application claims the benefit of and priority to U.S. Provisional Patent Application No. 63/705,616, filed on Oct. 10, 2024, the contents of which are incorporated herein by reference in their entirety.

### BACKGROUND

5G New Radio (NR) is touted as bringing a new era of connectivity by promising unprecedented data speeds, and ultra-low latency. A wide range of applications can benefit from such advantages, e.g., applications from immersive augmented reality (AR) experiences, and autonomous vehicles to critical healthcare services, and real-time video analytics. To meet the performance requirements of these emerging use cases, the majority of 5G operators have turned to Time Division Duplex (TDD), whereas previous technologies (e.g., LTE, 3G) mainly relied on Frequency Division Duplex (FDD). TDD alternates uplink (UL) and downlink (DL) transmissions within the same frequency band using time slots to enable flexible spectrum utilization and dynamic UL/DL resource allocation.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example mobile communication network in which examples of the disclosed technology may be implemented.

FIG. 2 illustrates an example of 5G NR's frame structure.

FIG. 3A illustrates an example TDD policy adjustment system architecture.

FIG. 3B illustrates an example neural network modeling of TDD policy.

FIG. 4 is a computing component that may be used to implement TDD policy adjustment in accordance with one example of the disclosed technology.

FIG. 5 is an example computer system that may be used to implement various features of TDD policy adjustment in accordance with examples of the presently disclosed technology.

The figures are not exhaustive and do not limit the present disclosure to the precise form disclosed.

### DETAILED DESCRIPTION

In a cellular network, base station (BS) “resources” for UL and DL can refer to the allocated time (or frequency in the case of FDD) slots within the radio spectrum that a BS can use to transmit data to (DL) wireless mobile devices or user equipment (UE) or receive data from (UL) UEs, like phones. The allocating of BS resources allows for the management of the “bandwidth” available for communications between a BS and connected UEs. Typically, a scheduler within a BS can determine how to distribute these resources across different users depending the users' traffic needs. Resources can be divided into units referred to as “resource blocks.”

As noted above, 5G operators have turned to TDD as a preferred channel access method. TDD can refer to the use of time (in particular, time slots) to separate the transmission and receipt of signals/frames. Thus, a single frequency can be assigned to a UE for both UL and DL data transmission, where UL and DL transmissions can be alternated according to some TDD pattern. Traditionally, a TDD policy reflects some static allocation of BS resources following such a TDD pattern. For example, 20% of BS resources may be assigned to UL time slots, while 80% of BS resources may be assigned to DL time slots. This allocation/TDD policy can be set for a network, and maintained throughout the lifetime of the network. It can be understood that such static allocation of BS resources cannot adapt to changing traffic conditions, changing UE/application requirements, and so on.

To accommodate different traffic patterns, 5G NR introduces dynamic TDD. A BS can dynamically change, in real-time, the distribution of UL and DL time slots, given that 5G NR accommodates a flexible numerology and frame structure. However, and although the 3GPP specifications cover the mechanism for enabling dynamic TDD, they leave the actual TDD policy implementation open for network operators.

Accordingly, examples of the disclosed technology are directed to systems and methods that effectuate a two-stage TDD policy adjustment service or mechanism at a BS. The two stages can include: (1) a proactive demand customization/prediction stage; and (2) a context-aware policy provisioning stage. From raw BS data, traffic, BS load, channel quality, and QoS features can be created, and used as input to a reinforcement learning (RL) agent that can predict future traffic demand at the BS, which can be output as UL/DL slots and symbols percentage distribution, i.e., a TDD pattern. Once the slots and symbols distribution (TDD pattern) is determined, the TDD pattern/distribution can be optimized via smoothing or reducing abrupt TDD policy changes (adjacent timeslots being assigned to UL and DL transmissions), and smoothing guard period overhead and inter-timeslot delay in accordance with a determined TDD pattern. As will be described in greater detail below, the distribution of slots and symbols making up those slots can include UL, DL, and guard symbols, and thus provides for different levels of granularity according to which a TDD policy can be developed or determined.

It should be noted that while examples of the disclosed technology may be described in the context of 5G/5G NR, examples of the disclosed technology need not be limited to 5G networks. That is, examples of the disclosed technology for implementing the TDD policy adjustment service can be realized in other networks/using other communication standards that have a flexible numerology and frame structure, e.g., 6G, 7G, or others that are now-known or later-developed.

It should also be noted that examples of the disclosed technology provide, as discussed above, mechanisms for achieving real-time and dynamic TDD. In other words, the determination and optimization of a TDD pattern, and the smoothing and QoS-aware TDD policy derivation based on a TDD pattern is performed while the communication network is operational and working. Thus, examples of the disclosed technology provide a computer or computerized solution (using artificial intelligence (AI)/machine learning (ML) techniques based on real-time, operational raw BS data or telemetry) to a computer or computerized problem regarding the implementation of dynamic TDD or similar time-based distribution of communication resources in a computerized communications network.

It should further be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

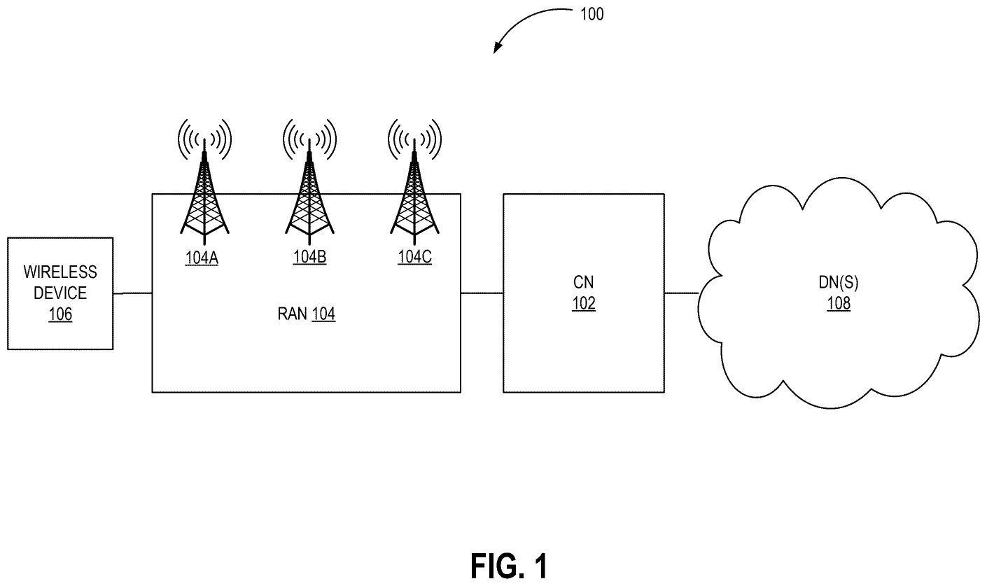

FIG. 1 illustrates an example of a mobile communication network 100 in which embodiments of the present disclosure may be implemented. The mobile communication network 100 may be, for example, a public land mobile network (PLMN) run by a network operator. As illustrated in FIG. 1, the mobile communication network 100 includes a core network (CN) 102, a radio access network (RAN) 104, and a wireless device 106.

The CN 102 may provide the wireless device 106 with an interface to one or more data networks (DNs) 108, such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink (DL) and the communication direction from the wireless device 106 to the RAN 104 over the air interface is known as the uplink UL). Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more BSs (e.g., BSs 104A, 104B, and 104C). The term BS may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A BS may comprise at least one gNB Central Unit (gNB-CU) and at least one a gNB Distributed Unit (gNB-DU).

A BS included in RAN 104 may include one or more sets of antennas for communicating with the wireless device 106 over the air interface. For example, one or more of the BSs 104A, 104B, or 104C may include three sets of antennas to respectively control three cells (or sectors). The size of a cell may be determined by a range at which a receiver (e.g., a BS receiver) can successfully receive the transmissions from a transmitter (e.g., a wireless device transmitter) operating in the cell. Together, the cells of the BSs may provide radio coverage to the wireless device 106 over a wide geographic area to support wireless device mobility.

In addition to three-sector sites, other implementations of BSs are possible. For example, one or more of the BSs 104A, 104B, or 104C in RAN 104 may be implemented as a sectored site with more or less than three sectors. One or more of BSs 104A, 104B, or 104C in RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell BSs that have similar antenna patterns and similar high-level transmit powers. The RAN 104 may be deployed as a heterogeneous network. In heterogeneous networks, small cell BSs may be used to provide small coverage areas, for example, coverage areas that overlap with the comparatively larger coverage areas provided by macrocell BSs. The small coverage areas may be provided in areas with high data traffic (or so-called “hotspots”) or in areas with weak macrocell coverage. Examples of small cell BSs include, in order of decreasing coverage area, microcell BSs, picocell BSs, and femtocell BSs or home BSs.

As described herein, a BS, such as one or more of BSs 104A, 104B, or 104C, can host a TDD policy adjustment system or mechanism that is capable of dynamically adjusting the distribution and arrangement of UL and DL time slots for improving an application's Quality of Experience (QoE) without any QoE feedback from the UE or application server. Examples of the disclosed technology are able to provide flexibility in defining TDD policies, despite problems that arise when attempting to define TDD policies. Defining TDD policies can necessitate exploring numerous UL and DL slot arrangements, making the complexity of defining TDD policies a problem. Additionally, rapidly fluctuating traffic load and channel conditions should be taken into consideration. Further still, limited information about application QoE goals may imply the lack of a well-defined optimization objective, not to mention that frequent TDD policy adjustments can interfere with transport-layer congestion control or application-layer rate adaptation logic. Lastly, the inherent asymmetry between UL and DL transmission, with UL typically experiencing higher latency and lower throughput, further complicates optimization of a TDD policy.

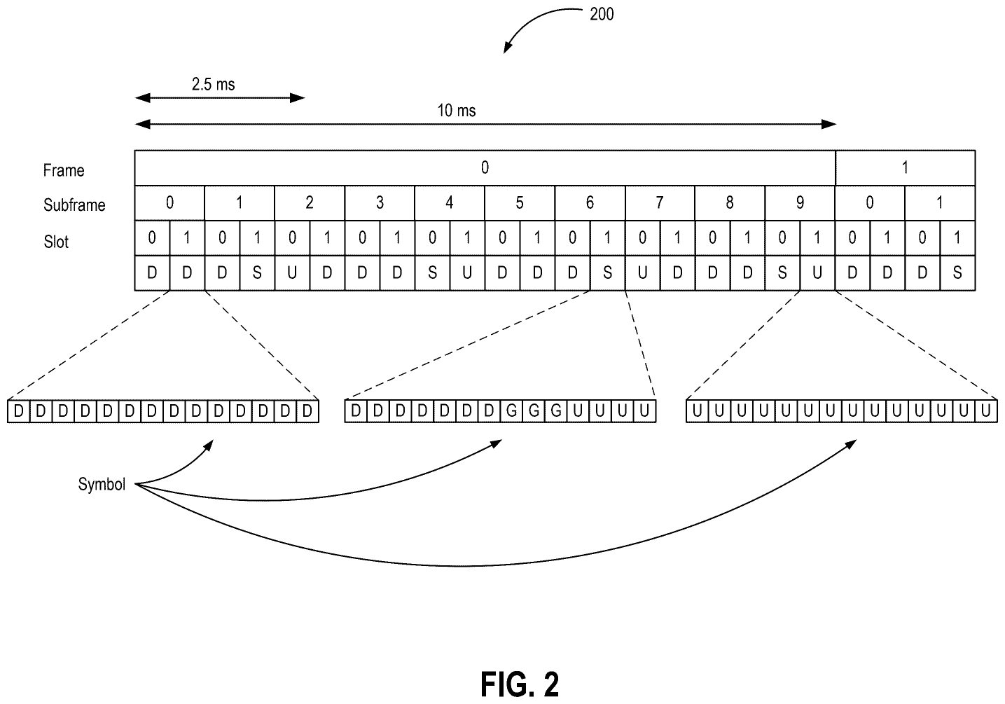

FIG. 2 illustrates a hierarchical frame structure that can accommodate flexible numerology. The example 5G frame structure is based on a slot and symbol-based design, meaning a 5G network can dynamically adjust the duration of each time slot based on a service's/application's needs. A data-heavy service might get longer slots, while services needing quick response times, like remote surgery or smart factories, might be allocated shorter slots. This flexibility improves the efficiency and responsiveness of the 5G network. The 5G frame structure includes both self-contained and non-self-contained subframes.

Numerology refers to the set of parameters that define the physical layer structure, specifically, the subcarrier spacing, symbol duration, and cyclic prefix length in an orthogonal frequency-division multiplexing (OFDM) system. Compared to LTE numerology (subcarrier spacing and symbol length), 5G NR can support multiple different types of subcarrier spacing (in LTE there is only one type of subcarrier spacing, 15 KHz). Each numerology is labeled or referred to as a parameter μ. In 5G, numerology (μϵ[0,4]) enables various subcarrier spacings to meet different service requirements.

As illustrated in FIG. 2, the frame structure is hierarchical, wherein a 10 ms radio frame contains 10 subframes (1 ms each), and subframes are divided into 2μ slots based on the BS numerology, with each slot lasting 2-μ ms. This slot duration, also known as Transmission Time Interval (TTI), is the smallest unit for scheduling and transmission in 5G NR. Each slot typically contains 14 OFDM symbols with a normal cyclic prefix. The “D” denotes that a slot is assigned to DL transmissions, the “U” denotes that a slot is assigned to UL transmissions, while the “S” denotes that a slot is special, i.e., shared between UL and DL transmissions. In a shared slot, such as the second slot “1” of subframe “6” of frame “0,” one or more guard symbols provides a guard period. A guard period is provided between transitions from UL to DL and from DL to UL transmission. The guard period can help ensure that the BS has time to switch from UL and DL transmissions (the switching of BS resources), and so that UL and DL transmissions do not interfere with one another at the BS by providing a period of time when neither DL nor UL transmissions occur.

As will be described in greater detail below, examples of the disclosed technology can dynamically adjust or adapt a BS's TDD policy by first predicting a TDD pattern. That is, examples of the disclosed technology are directed to a system for predicting a UL and DL slot distribution for one or more future frames. In the example illustrated in FIG. 2, the UL/DL slot distribution reflects 12 DL symbols and 3 UL symbols per 20-slot frame. The number of future frames (or how far in the future) for which UL/DL slot distribution is predicted can vary (and is configurable). For example, the more frames that are predicted (in the future), the resulting TDD policy may be less accurate than if a TDD policy regarding a smaller number of future frames is predicted. However, the time and compute resources needed to make more frequent predications can negatively impact processing performance. In some examples, a learning-based (e.g., Artificial Intelligence (AI)/Machine Learning (ML)) approach can be used in conjunction with/taking into consideration derived or generated BS-level features for handling highly complex network environments. The use of AI/ML that considers BS-level features also allows for the management of any asymmetry between UL and DL transmissions. That is, a particular application or service may not necessarily involve a one-to-one transmission pattern between UL and DL transmissions. For example, a media content delivery application, such as a streaming video application, typically involves more data being transmitted in the DL direction (from a BS towards a UE) than data being transmitted in the UL direction (from the UE towards the BS).

Second, in order to find an optimal arrangement of UL and DL slots given a particular slot distribution (TDD policy), a smart policy provisioning framework is provided. As noted above, examples of the disclosed technology need not rely on QoE information. Thus, in some examples, during this second part or phase of the TDD policy adjustment system, the radio protocol layer Quality of Service (QoS) metrics are optimized, thereby indirectly improving performance of an application or service. Examples of the disclosed technology can be particularly advantageous when handling traffic for applications that have stringent bandwidth or latency requirements. This is because the consideration of BS-level features and QOS metrics allows examples of the disclosed technology to, in effect, provide “tunable knobs” that a BS/RAN can use to fine-tune UL versus DL transmission priorities. In this way, examples of the disclosed technology can provide a balance between network bandwidth and latency.

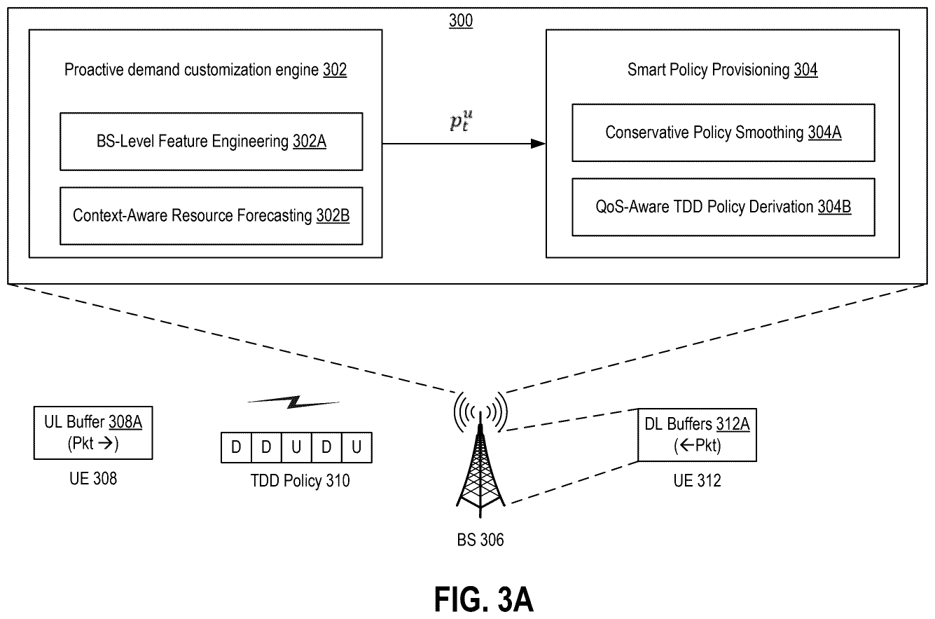

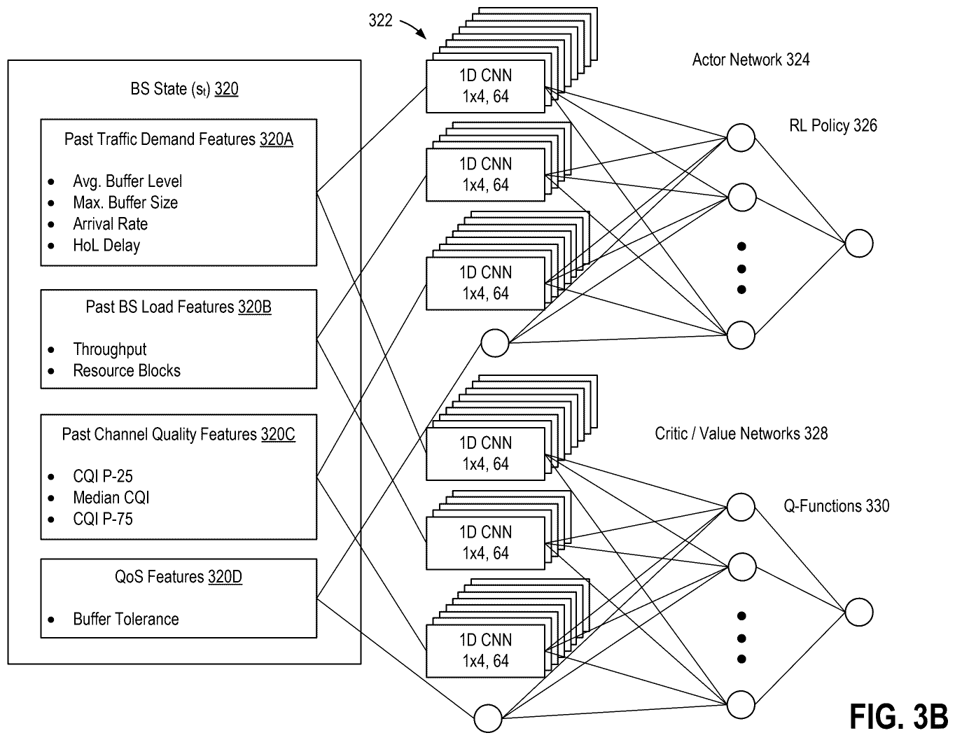

FIG. 3A illustrates a TDD policy adjustment system architecture in accordance with examples of the disclosed technology. Again, a two-stage approach is provided for TDD policy adjustment, where first, the TDD pattern (UL/DL slot and symbol distribution) is predicted based on BS context (i.e., operating characteristics). BS context can include, but is not necessarily limited to, traffic load, and channel quality. Once the UL/DL symbol and slot distribution is predicted, the optimal symbol and slot arrangement making up a TDD policy can be determined. The optimal symbol and slot arrangement takes into account inter-slot latency (the time needed to find the correct symbols and resource blocks to transmit a packet in a first slot of a frame/subframe) and guard period overhead (the amount of time between/during the transition from DL to UL transmissions and vice-versa.

The decomposition of TDD policy adjustment into two stages can significantly reduce the “search space” to determine the optimal symbol and slot arrangement compared to an exhaustive search method. In one example only 5-25 arrangements for a numerology of μ=1 (a 58-290× reduction). That is, and by predicting a TDD pattern considering the BS context, the optimization process to determine the TDD policy from that TDD pattern is made easier. For example, without first determining the TDD pattern in light of the BS context, all possible slots and symbols arrangements would have to be evaluated (i.e., 1450 arrangements for μ=1). However, with this decomposition, that number can be brought down significantly (i.e., 5 [290× reduction from 1450] to 25 [58× reduction from 1450]). In some examples, the two-stage approach can incur performance losses due to an inaccurately-predicted TDD policy, but the performance losses are minimal. To mitigate these performance losses, examples of the disclosed technology employ the aforementioned AI/ML approach in conjunction with BS context, thereby balancing network complexity and UL/DL transmission asymmetry. Furthermore, and as will be described in greater detail below, the second stage utilizes a conservative policy smoothing technique to prevent abrupt TDD policy changes (the changes from UL to DL and from DL to UL). In this way, the interference between transport-layer congestion control and application-layer rate adaptation logic can be minimized. That is, the reliability of data transmissions through the management of network traffic to control the rate and the volume at which data is transmitted (transport-layer congestion control) can be balanced with the transmission rates associated with optimally supporting applications given the state of the network (application-layer rate adaptation logic).

As illustrated in FIG. 3A, a TDD policy adaptation system 300 may comprise a proactive demand customization engine 302 and a smart policy provisioning engine 304. As noted above, examples of the present application adapt TDD policy at the BS using a two-stage process. In the first stage, the proactive demand customization engine 302 predicts a BS's UL/DL slot and symbols distribution according to which BS radio resources are assigned or utilized. This UL/DL slot and symbols distribution is not determined based solely on needed UL and DL capacity, but is determined in consideration of BS context. In the second stage, a determined or predicted TDD policy is shaped/smoothed to improve application QoE by smart policy provisioning engine 304.

As further illustrated in FIG. 3A, UEs, an example of which is UE 308, can request radio resources from a BS, in this example, BS 306. UE 308 may obtain allocated radio resources (UL and DL) from BS 306, and may subsequently transmit data in the UL direction to BS 306. As illustrated in FIG. 3A, UE 308 may transmit data in accordance with a UL packet buffer 308A. In the DL direction, any incoming data (from a server, another UE, etc., in this case server 312) may arrive at BS 306, and assigned to per-UE DL packet buffer queues 306A. One of the DL packet buffer queues 306A may correspond to UE 308, and NS 306 may transmit any queued data to UE 308. Ensuring that BS 306 effectively balances available TDD slots and symbols between UL and DL radio resources such that UEs, such as UE 308 receives sufficient resources promptly is important to improving an application's QoE. TDD policy adaptation system 300 operates as a lightweight service at BS 306 to effectuate timely TDD policy adjustment. As will be described in greater detail below, TDD policy adjustment system 300 takes in and leverages traffic, BS load, channel quality, and QoS features (which can gleaned from BS 306) to determine a TDD policy, such as TDD policy 310. TDD policy adjustment system 300 may then output an optimized TDD pattern that guides BS 306's TDD policy adjustment.

Proactive demand customization engine 302 can accurately predict future UL and DL resource demands for a UE/application running on a UE, such as UE 308. In particular, BS-level feature engineering module 302A can leverage cross-layer BS-level features to capture the RAN context (operating characteristics). The cross-layer BS-level features include the aforementioned transport-layer congestion control and application-layer rate adaptation. The RAN context can then be fed into a context-aware resource forecasting module 302B which can output an appropriate slots and symbols percentage distribution(s)/allocation(s) for the UL and DL radio resources. As will be described below, this percentage distribution or allocation can be referred to as “pₜ^{u}.” It should be noted examples of the disclosed technology predict UL radio resource allocation. Determining or predicting DL radio resource allocation is simply a matter of assigning the remaining percentage to DL resources. That is, examples of the disclosed technology need not actually determine both UL and DL resource allocations because the DL resource allocations can be calculated from the determined UL resource allocations. For example, if context-aware resource forecasting module 302B predicts or outputs a UL resource allocation that amounts to 30 percent, the corresponding DL resource allocation will be 70 percent. In other examples of the disclosed technology, DL resource allocations may be determined, and UL resource allocations can be calculated therefrom.

Smart policy provisioning engine 304 operates by first applying conservative (TDD) policy smoothing (via a conservative policy smoothing module 304A) to reduce any negative/unwanted impact of abrupt TDD policy changes on application QoE. That is, and for example, a TDD policy where a DL resource is assigned and immediately thereafter, a UL resource is assigned, can negatively impact an application's operation or QoE because it may require some transition time or period between transmitting/receiving data to/from a server, another UE, etc. In another example, an application's data traffic may benefit from the majority of its data being transmitted in one direction (UL or DL) with intermittent data transmission in the opposite direction (DL or UL). QoS-aware TDD policy derivation module 304B may then compute a final arrangement of UL and DL slots and symbols within a TDD policy (that can include guard periods between UL and DL symbol transitions). In this way, the tradeoff between inter-slot delay (which impacts network latency) and guard period overhead (which impacts network throughput, since no data is being transmitted/received during guard periods) can be optimally or at least, judiciously balanced.

As noted above, generated or derived BS-level features are taken into consideration by TDD policy adaptation system 300 to accurately predict future UL and DL resource demands for a UE/application running on a UE. Such BS-level features can be gleaned from raw BS logs. As will be described below, such BS-level features can include (but are not necessarily limited to) traffic demand features, BS load features, channel quality features, and QoS features. Such BS-level features can constructed by BS-level feature engineering module 302A of proactive demand customization engine 302, and passed to context-aware resource forecasting module 302B (in essence, a reinforcement learning (RL) agent) that can, in some examples, employ a neural network (NN) to interpret the RAN context which is represented by the BS-level features.

FIG. 3B illustrates an example neural network modeling of TDD policy. The state of a BS (sₜ) 320 can comprise past traffic demand features 320A (average data transmission buffer level, maximum buffer size, data packet arrival rate, and head-of-lines (HoL) delay), as well as past, BS load features 320B (the data throughput of the BS and the BS's resource blocks). Further still, the state of BS 320 can comprise past channel quality features 320C (the median, 25^{th} percentile, and 75^{th} percentile channel quality indicator (CQI) values.) and QoS features 320D (represented by buffer tolerance). It should be noted that this particular percentile distribution may be used so that the variance in CQI values may be appreciated by the NN model. That is, if, for example, the NN model only considered the 50^{th} percentile or median CQI values, the NN model would be unable to consider the diversity in CQI values—only the median CQI values. Moreover, although the described example considers the median, 25^{th}, and 75^{th} percentile CQI values, other percentiles can be considered, e.g., 20^{th}, 30^{th}, 70^{th}, 80^{th}, etc. Again, examples of the disclosed technology seek to understand the diversity of channel quality, and any appropriate spread of range of CQI value percentiles may be used to determine the state of BS 320. Such CQI values can be obtained directly from raw logs. Each of these “sets” of features can be represented by a neural network comprising a single dimensional convolutional NNs (CNNs) with a 1×4 kernel size and 64 filters, making up actor network 324 that can be based on a given RL policy (described in greater detail below). As will be described in greater detail below, a goal of context-aware resource forecasting module 302B is to output an action, aₜ, based on an RL policy 326 pₜ^{u}=π^{θ}(aₜ|sₜ). It should be understood that as noted above, and as will be discussed in greater detail below, aspects of the disclosed technology base determinations and optimizations using “past” data. Nevertheless, “past” as used herein can refer to immediate or near-immediate past data or measurements that can be used to effectuate real-time or near-real time dynamic TDD in accordance with examples of the disclosed technology that, as noted above, is a computer-based solution that would otherwise be incapable of being performed by a person. For example, the systems and methods disclosed herein may look at past data on the millisecond-scale (e.g., the past 2 ms to 500 ms of data), and decisions can be made with the aim of positively affecting an application's QoE within the next few milliseconds. Because network conditions are extremely dynamic, by the time a human inspects data, determines an appropriate policy, and applies that policy, network conditions would have already changed so much that there is little to no chance that the human-determined policy would be of any help in optimizing TDD policy.

A first set of BS-level features that can be considered can be made up of traffic demand features (past traffic demand features 320A) comprising average data transmission buffer occupancy levels at a BS, traffic arrival rates, and head-of-line delays. Such traffic demand features can be used to understand the traffic demands of active users of a BS, nₜ. Average buffer occupancy levels,

$${B}_{t}^{u} and {B}_{t}^{d} ,$$

maximum buffer levels

$${M}_{t}^{u} and {M}_{t}^{d} ,$$

traffic arrival rates,

$${A}_{t}^{u} and {A}_{t}^{d} ,$$

and head-of-line (HoL) delays

$${H}_{t}^{u} and {H}_{t}^{d}$$

at a time t can be concatenated to create traffic demand feature vector,

$$\vec{{D}_{t}} .$$

### That is,

$$\vec{{D}_{t}} = \{ {B}_{t}^{u} , {B}_{t}^{d} , {M}_{t}^{u} , {M}_{t}^{d} , {A}_{t}^{u} , {A}_{t}^{d} , {H}_{t}^{u} , {H}_{t}^{d} \} ,$$

where for each metric, u and d represent the UL and DL directions, respectively. Average buffer occupancy level in the UL direction,

$${B}_{c}^{u} ,$$

can be calculated as

$${\sum }_{i} {b}_{t}^{u , i} / ( {n}_{t} * c ) , where {b}_{t}^{u , i}$$

can represent the buffer level, and c is the radio link control (RLC) buffer capacity for UE i. The maximum buffer level across all UEs can be calculated as

$${M}_{t}^{u} = {max}_{i} ( {b}_{t}^{u , i} / c ) .$$

The data arrival rate,

$${A}_{t}^{u} ,$$

indicates how quickly data is arriving in the UL buffers (e.g., UL buffer 308A of FIG. 3A). Each UE's arrival rate,

$${a}_{t}^{u} = {λ}_{t}^{u , i} * {\hat{s}}_{t}^{u , i}$$

can be modeled as a Poisson process, where

$${λ}_{t}^{u , i}$$

is the inter-packet arrival rate, and

$${\hat{s}}_{t}^{u , i}$$

is the average packet size. The overall arrival rate,

$${A}_{t}^{u}$$

is the sum of individual UE arrival rates, i.e.,

$${A}_{t}^{u} = {\sum }_{i} {a}_{t}^{u , i} .$$

The HoL delay

$$( {H}_{t}^{u} = {\sum }_{i} {h}_{t}^{u , i} / {n}_{t} )$$

is the average HoL delay experienced by all UEs. It should be understood that the DL counterparts of these metrics in

$$\vec{{D}_{t}}$$

follows the same terminology.

A second set of BS-level features that can be considered in accordance with examples of the disclosed technology can be made up of BS load features (past BS load features 320B) comprising throughput and resource blocks. BS load features

$$\vec{{ℒ}_{t}} = \{ {T}_{t}^{u} , {T}_{t}^{d} , {R}_{t}^{u} , {R}_{t}^{d} \}$$

can be considered to capture and understand the effect of traffic demand on a BS's radio resources. An equation

$${T}_{t}^{u} = {\sum }_{i} {t}_{t}^{u , i}$$

may be used to represent the UL BS throughput, where

$${t}_{t}^{u , i}$$

is a UE's UL throughput normalized by the BS's maximum throughput. Total resource utilization,

$${R}_{t}^{u} = {\sum }_{i} {r}_{t}^{u , i} ,$$

can be calculated as the sum of the normalized UL resource blocks,

$${r}_{t}^{u , i} ,$$

assigned to each UE, where the normalization is performed against the total number of the BS's resource blocks.

A third set of BS-level features that may be considered when predicting the UL/DL policy are channel quality features (past channel quality features 320C) that include 25^{th}, 50th, and 75^{th} percentile CQI values. It should be understood the CQI information is incorporated given then impact that channel conditions have on network performance. However, simply averaging individual UE's wideband CQIs,

$${c}_{t}^{u , i} ,$$

is insufficient in practice because UEs tend to encounter widely varying channel conditions in the real world. Accordingly, encoding meaningful information about channel diversity, as set forth herein, includes considering the 25^{th}, 50^{th} (median), and 75^{th} percentile CQI values (or other percentile CQI values) to generate channel quality features,

$$\vec{{C}_{t}} = \{ P - {25}_{i} ( {c}_{t}^{u , i} ) , P - {25}_{i} ( {c}_{t}^{d , i} ) , P - {50}_{i} ( {c}_{t}^{u , i} ) , P - {50}_{i} ( {c}_{t}^{d , i} ) , P - {75}_{i} ( {c}_{t}^{u , i} ) ,$$

$$P - {75}_{i} ( {c}_{t}^{d , i} ) \} .$$

Yet another, and the fourth, set of BS-level features considered in accordance with examples of the disclosed technology are QoS features (QoS features 320D) that include a BS's buffer tolerance. A BS's buffer tolerance factor, ρₜϵ[0,1], can indicate a BS's cumulative buffering tolerance for UE's, e.g., all UEs, serviced by the BS. A low tolerance (ρₜ≃0) loosely indicates or represents latency-sensitive traffic.

Once the BS-level features that represent the RAN context have been constructed as described above, the UL/DL policy can be predicted by considering or performing the prediction in light of the BS-level features via context-aware resource forecasting. As discussed above, BS-level feature engineering module 302A passes the constructed BS-level features to context-aware resource forecasting module 302B. This forecasting or predicting of the TDD UL/DL policy can be optimized based on three QoS metrics, referred to herein for ease of reference, as “O1,” “O2,” and “O3.” The O1 metric maximizes the sum of UL and DL BS throughput, represented as

$$max {T}_{t}^{u} and max {T}_{t}^{d} ,$$

respectively. The O2 metric minimizes network latency, which can be estimated as the highest buffer occupancy level for all UEs, represented as

$$min {T}_{t}^{u} and min {T}_{t}^{d} ,$$

respectively. That is, the highest buffer occupancy correlates to the time that elapses between sending data and receiving a corresponding response, and the amount of time that data is “stuck” in a buffer, when that buffer is at its maximum capacity causes the latency). The O3 metric can be used to optimize context-aware resource forecasting by avoiding data loss. Data loss can be approximated by or as the buffer overflow tendency of RLC queues, represented as min

$$1 - {M}_{t}^{u} and min 1 - {M}_{t}^{d} ,$$

respectively. That is, data can be lost when there is no buffer space left to store data waiting to be transmitted.

As discussed above, context-aware resource forecasting, in some examples, can be operationalized as an RL agent. In some examples, the RL agent (context-aware resource forecasting module 302B) combines the O1, O2, and O3 metrics into a reward function, rₜ. The O2 and O3 metrics create a trade-off with metric O1, i.e., reward is increased if the BS throughput is high and the worst buffering delay is low. Hence, examples of the disclosed technology leverage buffer tolerance factor, ρₜ, to determine the weight for each objective, where ηϵ[0,1] represents UL traffic priority. The aforementioned combination of the O1, O2, and O3 metrics is represented by the following equation (Eqn. 1).

$${r}_{t} = η ( {T}_{t}^{u} + {ρ}_{t} - {M}_{t}^{u} ) + ( 1 - η ) ( {T}_{t}^{d} + {ρ}_{t} - {M}_{t}^{d} ) \qquad ( Eqn . 1 )$$

At each time step, t, context-aware resource forecasting module 302B receives BS state inputs,

$${s}_{t} = \{ \vec{{D}_{t - k : t}} , \vec{{ℒ}_{t - k : t}} , \vec{{C}_{t - k : t}} , {ρ}_{t} \}$$

for its neural network.

$$\vec{{D}_{t - k : t}} , \vec{{ℒ}_{t - k : t}} , \vec{{C}_{t - k : t}} , {ρ}_{t}$$

are representative of traffic demand, BS load, and channel quality feature vectors, respectively, for the past k time steps.

Given the BS's state, sₜ, context-aware resource forecasting module 302B predicts the needed UL slots and symbols percentage, i.e.,

$${a}_{t} = {p}_{t}^{u} ϵ [ 0 , 1 ] .$$

It should be noted that the sum of

$$U L ( {p}_{t}^{u} ) , D L ( {p}_{t}^{d} ) ,$$

and guard period

$$( {p}_{t}^{g} )$$

slots and symbols percentages amounts to one, i.e.,

$${p}_{t}^{u} + {p}_{t}^{d} + {p}_{t}^{g} = 1 .$$

As illustrated in FIG. 3B, the actor network 324 is an example depiction of the manner in which a NN can be used to represent RL policy 326. Context-aware resource forecasting module 302B (i.e., the RL agent) seeks to maximize the expected cumulative reward, i.e.,

$$maxE [ {\sum }_{t = 0}^{∞} {r}_{t} ] ,$$

by outputting action aₜ based on an RL policy 326. RL policy 326 can be defined as the conditional probability distribution over policy π, where (aₜ|sₜ)ϵ[0,1], π(aₜ|sₜ) is the probability of action at given BS state sₜ. In practice, many {state, action} pairs, e.g., buffer level and throughput estimates that are continuous real numbers. Hence, examples of the disclosed technology employ a neural network, such as neural network 322, to model state is with a feasible number of trainable parameters, θ. Thus, RL policy 326 can be expressed as π_{θ}(aₜ|sₜ).

A soft actor-critic (SAC) algorithm can be used to train context-aware resource forecasting module 302B, as illustrated in FIG. 3B. SAC is able to concurrently learn a policy π_{θ} (i.e., actor network 324), and two Q-functions, Q_{φ1} and Q_{φ2} (i.e., the critic and value networks). A Q-function, denoted as Q(sₜ, aₜ), can represent the expected return (total accumulated reward) beginning from state, sₜ, taking action, aₜ, and subsequently following a policy, π. It should be understood that a critic network refers to a value function approximator that judges the quality of an action taken by an agent (here, the RL agent/context-aware resource forecasting module 302B) when performing reinforcement learning. Critic and value networks 328 takes state and action as inputs (described above), and outputs a critic value, the aforementioned judgment of the action's quality.

Again, examples of the disclosed technology predict a TDD UL/DL pattern considering BS-level features/RAN context, and then optimize the TDD UL/DL pattern to arrive at a TDD policy to reduce abrupt TDD policy changes using a conservative policy smoothing technique. This policy smooth technique is characterized as being conservative because it, in effect, slows down the process of changes in the TDD policy (recalling that abrupt TDD policy changes are undesirable). Theoretically, one would want to implement the derived TDD policy as-is, but again, doing so can cause issues that result from too-fast TDD policy changes. That is, and referring back to FIG. 3A, once the RL policy 326

$$( {p}_{t}^{u} )$$

is determined, that RL policy 326 can be passed on to smart policy provisioning module 304, where the aforementioned smoothing can be performed by conservative policy smoothing module 304A. Then, QoS-aware TDD policy derivation module 304B can balance the tradeoff between inter-slot delay and guard period overhead to determine the best possible TDD policy.

In terms of conservative policy smoothing, abrupt TDD policy changes due to fluctuating load can result in “misguided” transport-layer congestion control or application-layer rate adaptation logic. According, examples of the disclosed technology apply conservative policy smoothing techniques to a determined action

$$( {α}_{t} = {p}_{t}^{u} )$$

that has been generated by context-aware resource forecasting module 302B. Again, it should be noted that determining both UL and DL action/policy is unnecessary—determining one (UL or DL) policy is informative of the other (DL or UL) policy. The conservative policy smoothing technique applied by conservative policy smoothing module 304A can be represented by the following equations (Eqns. 2A, 2B, and 2C).

$${γ}_{t} = β {γ}_{t - 1} + ( 1 - β ) \vert {p}_{t}^{u} - {p}_{t - 1}^{u} \vert \qquad ( Eqn . 2 A )$$

$${α}_{t} = {γ}_{b}^{t} / max ( {γ}_{t - {t}_{s} : t} ) \qquad ( Eqn . 2 B )$$

$${\hat{p}}_{t}^{u} = {α}_{t} {p}_{t}^{u} + ( 1 - {α}_{t} ) {\hat{p}}_{t - 1}^{u} \qquad ( Eqn . 2 C )$$

Eqn. 2C represents a traditional Exponentially Weighted Moving Average (EWMA). Eqn. 2A applies another EWMA to smooth out TDD policy variation, γₜ, while Eqn. 2B normalizes

$${γ}_{b}^{t}$$

using a time window, [t−tₛ, t], where tₛ can be a large positive multiple of system time step length, Δt, for example, tₛ=30Δt.

Once,

$${\hat{p}}_{t}^{u}$$

(representing a weighted average of a sequence of calculated values of the RL/TDD UL policy) is known, QoS-aware TDD policy derivation module 304B determines the slots and symbols arrangement for TDD policy, [symbol] , while accounting for guard periods. However, deriving [symbol] is not straightforward. This is because inter-slot delay can have a significant impact on network latency and an application's QoE. The key challenge lies in balancing the tradeoff between minimizing inter-slot delay and managing guard period overhead. While, lower inter-slot delays reduce network latency, lower inter-slot delay increase DL→UL and UL→DL transitions (due to the need to introduce more guard periods to account for such symbol transitions between UL and DL), leading to a higher guard period overhead, and, ultimately reduced throughput. Accordingly, QoS-aware TDD policy derivation module 304B judiciously balances this tradeoff by finding a TDD policy with a minimum normalized weight between inter-slot delay and guard period overhead.

To find such a TDD policy with a minimum normalized weight between inter-slot delay and guard period overhead, QoS-aware TDD policy derivation module 304B first computes all possible arrangements of UL, DL, and guard slots and symbols given

$${\hat{p}}_{t}^{u} ,$$

g^{d,u}, g^{u,d}. It should be noted that certain standards/specifications, such as the 5G standard (or other standards/regulations to which examples of the disclosed technology can adhere), may define or set forth some list or set of allowed TDD patterns, where any TDD patterns that are not part of that allowed list/set may be considered “restricted” or “invalid.” Accordingly, only “valid” TDD patterns (slots and symbols arrangements) are generated for all suitable transmission periodicities to create a TDD policy set, [symbol] . For each TDD policy, s: s∈ [symbol] , QoS-aware TDD policy derivation module 304B can compute: (i) the guard period overhead, [symbol] , given by the percentage of guard slots and symbols in s, and (ii) the total inter-slot delay, [symbol] , for DL→UL and UL→DL transitions.

Inter-slot delay can dictate the minimum amount of time network packets spend in the per-UE queues waiting to be transmitted. Thus, the buffering tolerance factor, ρₜ, discussed above, can be leveraged to encode a preference for network latency. Then, ρₜ can be used to compute a normalized weight to get the best TDD policy, [symbol] , from [symbol] as arg min ( [symbol] ) as follows using Eqn. 3.

$${𝒲}^{𝒮} = {ρ}_{t} \frac{{d}^{𝒮}}{{\sum }_{𝒮 ∈ {𝒮}_{𝓉}} {d}^{𝒮}} + ( 1 - {ρ}_{t} ) \frac{{p}^{g , 𝒮}}{{\sum }_{𝒮 ∈ {𝒮}_{𝓉}} {p}^{g , 𝒮}} \qquad ( Eqn . 3 )$$

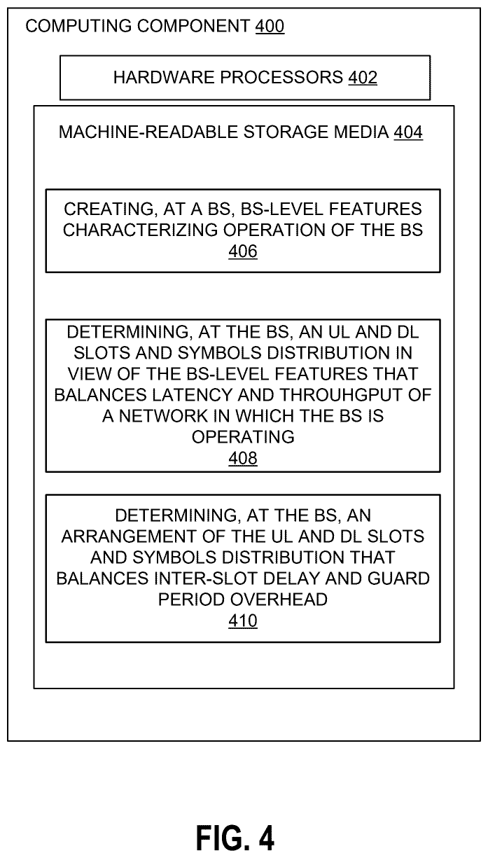

FIG. 4 illustrates a computing component that may be used to implement context-aware TDD policy adaptation in accordance with various examples of the disclosed technology. Referring now to FIG. 4, computing component 400 may be, for example, a server computer, a controller, or any other similar computing component capable of processing data. In the example implementation of FIG. 4, computing component 400 includes a hardware processor 402, and machine-readable storage medium 404.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-410, to control processes or operations for context-aware TDD policy adaptation. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 40 may be a non-transitory storage medium, where the term “non-transitory” does not encompass transitory propagating signals. As described in detail below, machine-readable storage medium 404 may be encoded with executable instructions, for example, instructions 406-410.

Hardware processor 402 may execute instruction 406 to create, at a BS, BS-level features characterizing operation of the BS. As described above, a TDD policy adaptation system comprising a BS-level feature engineering module can receive raw BS log data from the BS. From such raw BS log data, BS-level features can be generated, e.g., traffic demand features, BS load features, channel quality features, and QoS features. These BS-level features can be used to predict or forecast a “bare” UL/DL distribution or percentage, e.g., on a per-frame basis.

Hardware processor 402 may execute instruction 408 to determine, at the BS, an UL/DL slots and symbols distribution in view of the BS-level features that balances latency and throughput of a network in which the BS is operating. That is, context-aware resource forecasting module can forecast or predict the percentage of UL and DL slots and symbols taking into account, the BS-level features generated from the raw BS log data, where the UL/DL distribution can be optimized using a NN that balances maximizing BS throughput, minimizing network latency, and avoiding data loss. In some examples of the disclosed technology, at times, t, context-aware resource forecasting module can take BS state inputs, and predict a needed UL slots and symbols distribution or percentage (an action) based on an RL policy defined as a conditional probability distribution over a state sₜ.

Hardware processor 402 may execute instruction 410 to determine, at the BS, an arrangement of the UL and DL slots and symbols distribution that balances inter-slot delay and guard period overhead. That is, and once an optimal TDD policy is determined that sets forth the necessary UL/DL distribution, the TDD policy can be smoothed using a conservative policy smoothing technique that reduces abrupt UL/DL transitions. Once a smoothed TDD policy is determined via a QoS-aware TDD policy derivation module, a TDD policy that balances the tradeoff between reduced network latency (due to lower inter-slot delays), but resulting in increased UL/DL transitions (leading to higher guard period overhead), which results in reduced throughput.

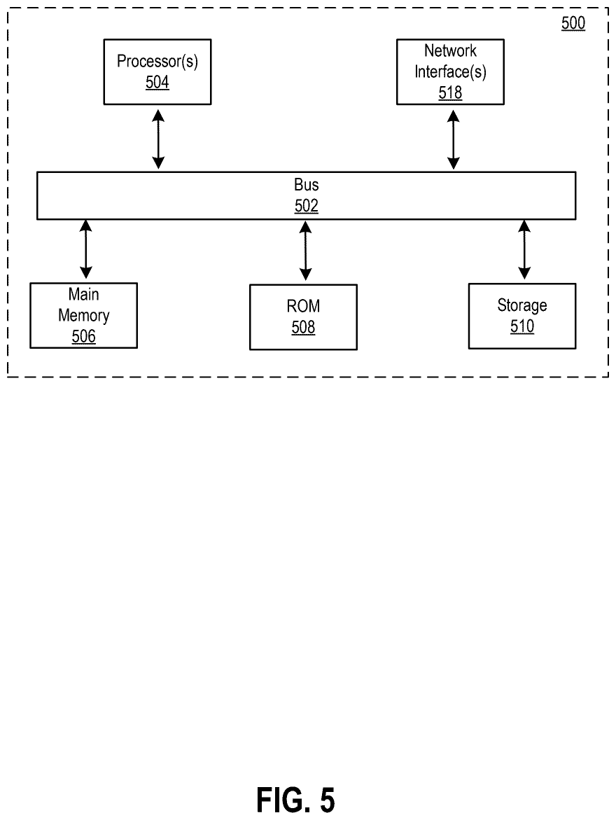

FIG. 5 depicts a block diagram of an example computer system 500 in which various examples of the disclosed technology described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors. Various aspects of the disclosed technology, such as a BS, the above-described TDD policy adaptation system (and its component parts/modules) can be embodied by one or more instances of computer system 500.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disk, such as storage device 510. Volatile media includes dynamic memory, such as main memory 506. Non-transitory media is distinct from but may be used in conjunction with transmission media.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
creating, at a base station (BS), BS-level features characterizing operation of the BS;
determining, at the BS, an uplink (UL) and downlink (DL) slots and symbols distribution in view of the BS-level features that balances latency and throughput of a network in which the BS is operating;
determining, at the BS, an arrangement of the UL and DL slots and symbols distribution that balances inter-slot delay and guard period overhead.

2. The method of claim 1, further comprising receiving, at the BS, raw BS-level logs, from which the BS-level features are created.

3. The method of claim 1, wherein the BS-level features comprise traffic demand features, BS load features, channel quality features, and quality of service (QoS) features.

4. The method of claim 3, wherein the traffic demand features are represented by a vector determined by concatenating average BS buffer occupancy levels, maximum BS buffer levels, traffic arrival rates at the BS, and head-of-line delays at the BS.

5. The method of claim 3, wherein the BS load features are represented by a vector reflecting an effect of traffic demand on the BS's resources determined based on UL throughput at the BS per user equipment (UE) normalized by maximum BS throughput, and the BS's total resource utilization.

6. The method of claim 3, wherein the channel quality features are represented by a vector determined by considering various percentile channel quality indicator (CQI) values.

7. The method of claim 3, wherein the QoS features are represented by the BS's cumulative buffering tolerance across UEs served by the BS.

8. The method of claim 7, wherein the determining of the UL and DL slots and symbols distribution comprises applying reinforcement learning (RL) to the BS-level features.

9. The method of claim 8, further comprising optimizing the UL and DL slots and symbols distribution based on a combination of maximizing a sum of UL and DL BA throughput, minimizing network latency, wherein network latency is estimated as a highest buffer occupancy level of UEs served by the BS, and avoiding data loss, wherein data loss is approximated as a buffer overflow tendency of radio link control (RLC) queues for the UEs served by the BS.

10. The method of claim 8, wherein the applied RL is modeled as a neural network receiving state inputs reflecting the traffic demand features, the BS load features, the channel quality features, and the quality of service (QoS) features over a plurality of past time steps.

11. The method of claim 10, wherein the applied RL predicts an action based on the received state inputs, the action comprising a UL slot and symbols percentage distribution.

12. The method of claim 11, wherein the determination of the arrangement of the UL and DL slots and symbols distribution comprises applying a smoothing technique to the predicted action for smoothing transitions between UL and DL transmissions reflected by the UL and DL slots and symbols arrangement.

13. The method of claim 12, wherein the smoothing technique is based on a first smoothing operation based on determining and applying a first exponentially weighted moving average to a UL distribution percentage, a second smoothing operation based on determining and applying a second exponentially weighted moving average to the UL distribution percentage, and normalizing the application of the second exponentially weighted moving average using a time window.

14. The method of claim 13, wherein the determination of the arrangement of the UL and DL slots and symbols distribution that balances inter-slot delay and guard period overhead comprises determining the arrangement of the UL and DL slots and symbols distribution having a minimum normalized weight between the inter-slot delay and the guard period overhead.

15. The method of claim 14, wherein the determination of the minimum normalized weight between the inter-slot delay and the guard period overhead comprises generating valid, possible UL and DL slots and symbols distributions that include guard periods.

16. The method of claim 15, wherein the determination of the minimum normalized weight between the inter-slot delay and the guard period overhead further comprises encoding a network latency preference using the cumulative buffering tolerance across UEs served by the BS to compute a normalized weight between the inter-slot delay and the guard period overhead.

17. A system, comprising:
a base station (BS)-level feature engineering module determining BS-level features based on raw BS log data, the BS-level features characterizing a radio access network (RAN) context;
a RAN context-aware resource forecasting module predicting a time division duplex (TDD) policy reflecting uplink (UL) and downlink (DL) slots and symbols distribution based on the RAN context;
a TDD policy smoothing module to mitigate impact of abrupt TDD policy changes on application quality of experience (QoE) based on the predicted TDD policy resulting in a smoothed TDD policy; and
a quality of service (QoS)-aware TDD policy derivation module computing an arrangement of UL and DL slots and symbols within a TDD pattern further including one or more guard periods according to which the BS assigns UL and DL radio resources based on the smoothed TDD policy.

18. The system of claim 17, wherein the BS-level features comprise traffic demand features, BS load features, channel quality features, and quality of service (QoS) features.

19. A system, comprising:
a processor; and
a memory comprising instructions that when executed, cause the processor to:
execute a reinforcement learning (RL) agent modeled as a neural network on a base station (BS) configured to receive state inputs reflecting traffic demand features, BS load features, channel quality features, and quality of service (QoS) features characterizing the BS over a plurality of past time steps, and output an uplink (UL) slots and symbols percentage distribution according to which BS resources are assigned;
computing a plurality of possible UL, downlink (DL), and guard period slots and symbols arrangements that comport with the UL slots and symbols percentage distribution, the DL slots and symbols being determined relative to the percentage distribution of the UL slots and symbols percentage distribution, and the guard period slots providing non-transmission periods between UL and DL slots and symbols transitions; and
selecting one of the plurality of possible UL, DL, and guard period slots and symbols arrangements that balances inter-slot delay and guard period overhead.

20. The system of claim 19, wherein prior to determining the plurality of possible UL, DL, and guard period slots and symbols arrangements, first determining an arrangement of the UL and DL slots and symbols distribution, and applying a smoothing technique to smooth transitions between UL and DL transmissions reflected by the arrangement of the UL and DL slots and symbols distribution.
